(19) United States
(12) Patent Application Publication
(10) Pub. No.: US 2004/0248563 A1
(43) Pub. Date: Dec. 9, 2004

(54) Method and system for processing call-forward telephone numbers received for a subscriber

(76) Inventors: John I. Ayers, Omaha, NE (US); Srinivas Chilukuri, Omaha, NE (US); Mark Gullett, Monument, CO (US); Tiffany A. Moore, Omaha, NE (US); Robert G. Miller, Omaha, NE (US)

Correspondence Address: HEWLETT-PACKARD COMPANY, Intellectual Property Administration, P.O. Box 272400, Fort Collins, CO, 80527-2400, US

(21) Appl. No.: 10/456,468

(22) Filed: Jun. 9, 2003

(51) Int. Cl. H04Q 7/20

(52) U.S. Cl. 455/417; 455/445; 455/426.1

(57) ABSTRACT

A method and system are disclosed for processing call-forward telephone numbers received by a computer system from a subscriber of the computer system. The computer system includes a call-processing subsystem and a provisioning subsystem. A call-forward number is received for a subscriber. The computer system identifies a class of service associated with the subscriber and reconfigures the call-forward number by prepending any missing digits and/or deleting any extraneous characters as necessary, based on the class of service. The computer system then validates the call-forward number, based on the subscriber's class of service. The reconfigured and validated call-forward number is stored by the computer system, and thereafter calls received for the subscriber are forwarded to the call-forward number.

### TECHNICAL FIELD

The technical field relates generally to the processing of telephone calls by a computer system, including calls sent to subscribers accessing the computer system with a wireless device. More particularly, the technical field relates to the fix-up and validation of call-forward numbers received for a subscriber.

### BACKGROUND

In the field of telecommunications and, in particular, in the context of wireless telecommunications devices, it is desirable to efficiently process telephone number information. It is also desirable for telecommunications devices, such as wireless telephones, personal data assistants, and messaging devices, to have capabilities to allow the devices to be used in various countries throughout the world. One problem with enabling wireless devices or telecommunications services to be used throughout the United States and throughout other countries is the requirement that area codes and country codes be included in telephone numbers dialed. It is cumbersome for users to enter complete telephone numbers, including country codes and area codes for every call, particularly for users who enter numbers primarily within a single country.

One particular context involves the processing of telephone numbers in connection with supplementary services, such as call forwarding features. For example, users of such devices can remotely configure call forwarding features by dialing a sequence of digits on a wireless telephone or interacting with a graphical user interface (GUI) of a personal data assistant (PDA) device, and entering a number to which calls should be forwarded (referred to herein as a “call-forward number” or “forward to number” or “FTN”). One problem with existing methods and systems for processing call-forward numbers is that users are required to enter a complete telephone number, including country codes and area codes, or otherwise use default country codes and area codes.

Another problem is that existing systems provide no way of differentiating between valid or invalid call-forward numbers. For example, a subscriber may inadvertently enter an incorrect number as the call-forward number. Or, someone other than the subscriber may obtain the subscriber's device without the subscriber's authorization, and may attempt to enter a call-forward number that is not appropriate, such as a 1-900 number that requires a charge to the subscriber, or a number that provides special services, such as 911, 411, 611.

### SUMMARY

A method is disclosed for processing call-forward telephone numbers received by a computer system from a subscriber of the computer system 10. A call-forward number is received for a subscriber. The computer system 10 identifies a class of service associated with the subscriber and reconfigures the call-forward number by prepending any missing digits, based on the class of service. The computer system 10 then validates the call-forward number, based on rules associated with the subscriber's class of service. The reconfigured and validated call-forward number is stored by the computer system 10, and thereafter calls received for the subscriber are forwarded to the call-forward number.

A computer system is also disclosed for processing call-forward numbers received for a subscriber of the system. The computer system has a storage medium and a processor for executing a software program stored on the storage medium. The software program includes sets of instructions for receiving a call-forward number for the subscriber, determining whether the call-forward number requires reconfiguration, identifying a class of service associated with the subscriber, reconfiguring the call-forward number based on the class of service, storing the reconfigured call-forward number, and redirecting incoming calls based on the reconfigured call-forward number.

A computer-readable medium is also disclosed, having computer-executable instructions for performing a method of processing call-forward numbers for a subscriber. A call-forward number is received for the subscriber. A class of service associated with the subscriber is identified, and one or more validation rules are identified for the class of service. The call-forward number is then validated based on the rules.

### DESCRIPTION OF THE DRAWINGS

The detailed description will refer to the following drawings, wherein like numerals refer to like elements, and wherein:

FIG. 1 shows a block diagram of a computer system that receives a call-forwarding signal from a subscriber of the computer system;

FIG. 2 shows a flow chart of a method of processing call-forward numbers received by the computer system;

FIGS. 3A-C show example screens of a graphical user interface (GUI) used to configure the validation rules in one embodiment;

FIG. 4 shows a flow chart of one embodiment of a method for reconfiguring the call-forward number; and

FIG. 5 shows a flow chart of one embodiment of a method for validating call-forward numbers.

### DETAILED DESCRIPTION

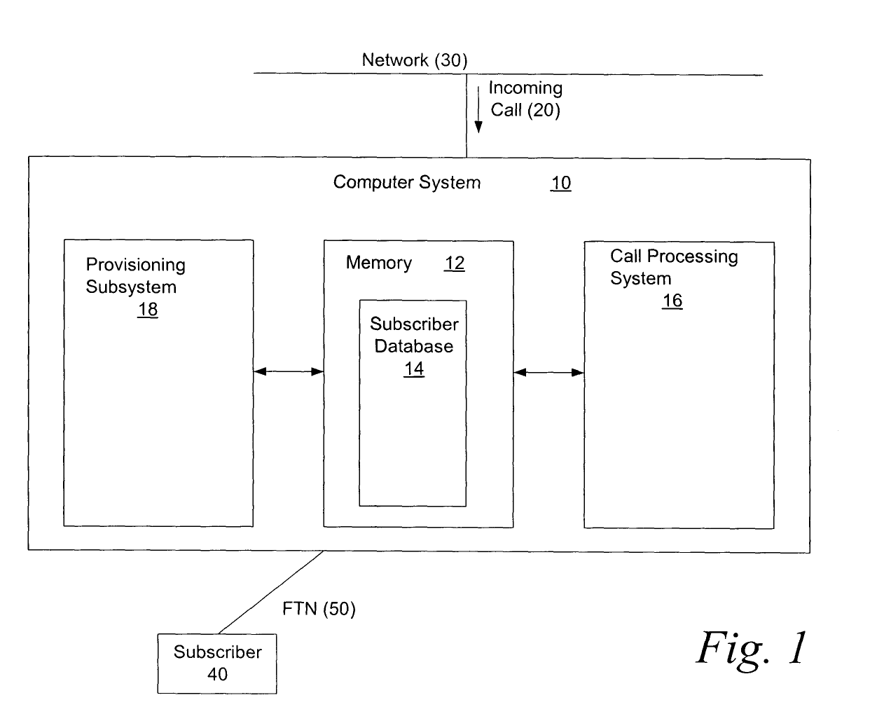

FIG. 1 shows a block diagram of a computer system 10 that receives a call-forward number 50 from a subscriber 40 associated with the computer system 10. The computer system 10 includes a memory 12 that stores subscriber information in a database 14. The computer system 10 also includes a call processing subsystem 16 that processes an incoming call 20 by delivering the call 20 to the subscriber 40. If the subscriber 40 has activated call forwarding, the call processing subsystem 16 forwards the call 20 to the call-forward number 50 provided for the subscriber 40. The computer system 10 further includes a provisioning subsystem 18 that is used to configure fix-up and validation rules for call-forward numbers (e.g., 50) received for the subscriber 40. The provisioning subsystem 18 includes a display device (not shown) that displays a graphical user interface (GUI) for entry of fix-up and validation rules for different classes of service. One or more subscribers are associated with each class of service, and classes of service are specified for the subscribers in the subscriber database 14. Call-forward numbers (e.g., 50) received for a subscriber 40 associated with a particular class of service are reconfigured and validated according to the fix-up and validation rules associated with the particular class of service, and those rules are configured using the provisioning subsystem 18.

Call forwarding may be activated by the subscriber 40 in various ways. In one example, the subscriber 40 activates call forwarding remotely, using the telecommunications device (e.g., wireless telephone, PDA, etc.). The computer system 10 receives the call-forward number 50 via a supplementary services message from the subscriber 40. The subscriber 40 may activate call forwarding by dialing a sequence of digits (e.g., *71) followed by the call-forward number. The call-forward number 50 may be a partial telephone number, depending upon how the subscriber 40 enters the number. For example, the subscriber 40 may enter a call-forward number without a country code or area code.

The computer system 10 reconfigures the call-forward number 50 to make it a complete number, including a country code and area code. The missing digits, if any, are added to the call-forward number 50 based on a class of service associated with the subscriber 40. The subscriber's class of service is included in the subscriber information database 14. In one embodiment, the subscriber's own country code, area code, and exchange code are prepended to all call-forward numbers that are entered by the subscriber 40 without the country code, area code, and/or exchange code. In another example, missing digits are added to the call-forward number 50 based on the geographic location of the subscriber's device. For example, the subscriber's own country code may be prepended to calls placed within the subscriber's home country, but when the subscriber 40 is in a different country, the country code of that different country is prepended. Similarly, when the subscriber 40 is in the subscriber's home country but travels to different area codes, the local area code of the area in which the subscriber 40 is physically located when entering the call-forward number 50 may be used. In these particular examples, the appended digits may be determined automatically, or may be controlled by the subscriber 40, such that the subscriber 40 can turn off the function that changes the appended country code when traveling to other countries. In still another embodiment, the class of service for the subscriber 40 specifies a plurality of rules for adding missing digits, such that different country codes or area codes are added to different call-forward numbers, based on the call-forward numbers. For example, all call-forward numbers with a particular area code may be associated with a particular country, and when the subscriber 40 provides any call-forward number 50 with the particular area code, the computer system 10 adds the country code specified by the rules. Similarly, all call-forward numbers with a particular exchange code may be associated by the rules with a particular area code and country code. For example, every time a subscriber 40 enters a 7-digit call-forward number with an exchange code “340,” the computer system 10 might automatically add the area code “612” to the call-forward number, and the country code 1.

In some examples, the call-forward number 50 includes additional, extraneous digits or characters, such as a # or * character entered from a wireless telephone. In these examples, the call-forward number 50 is reconfigured or “fixed-up” by deleting the additional characters, and by adding any missing digits, if necessary.

After reconfiguring or “fixing-up” the call-forward number 50, the computer system 10 also validates the call-forward number 50, based on rules that are configured for the subscriber 40. The rules may be specific to the subscriber 40, or may be configured by default based on the subscriber's class of service. For example, the subscriber 40 may want to prevent call forwarding to any number outside of the subscriber's country, because the subscriber 40 might never have occasion to forward calls to a number in another country. As such, any call-forward number 50 outside of the subscriber's home country is erroneously entered and should not be validated. Similarly, the subscriber 40 may want to prevent forwarding to any call-forward number having a particular area code or prefix, such as those area codes associated with fee-based calls (e.g., 900 area codes). The rules may also specify that certain specific call-forward numbers or area codes or prefixes are always validated. If the call-forward number is validated, the call-forward number is stored in memory 12 of the computer system 10, and incoming calls (e.g., 20) are thereafter forwarded to the call-forward number 50, while the call forwarding feature is activated.

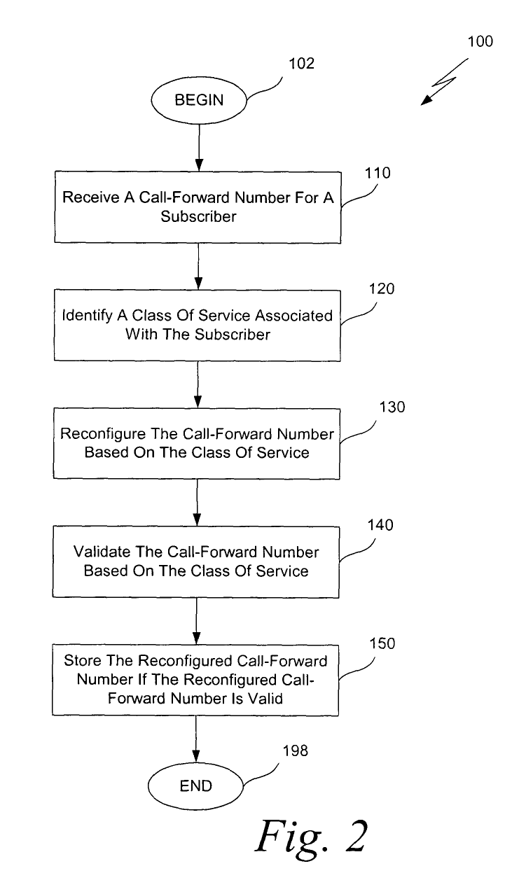

FIG. 2 shows a flow chart of an embodiment 100 of processing call-forward numbers received by the computer system 10. The example of FIG. 2 begins 102 and receives 110 a call-forward number for a subscriber 40. The computer system 10 identifies 120 a class of service associated with the subscriber 40 by accessing the subscriber database 14, and reconfigures 130 the call-forward number 50 by adding missing digits and/or deleting extraneous characters, as necessary. The call-forward number 50 is validated 140, and if the number 50 is valid the computer system 10 stores 150 the reconfigured call-forward number, and the example ends 198. Incoming calls (e.g., 20 in FIG. 1) are thereafter forwarded by the call processing system 16 to the reconfigured call-forward number, while the call forwarding feature is activated.

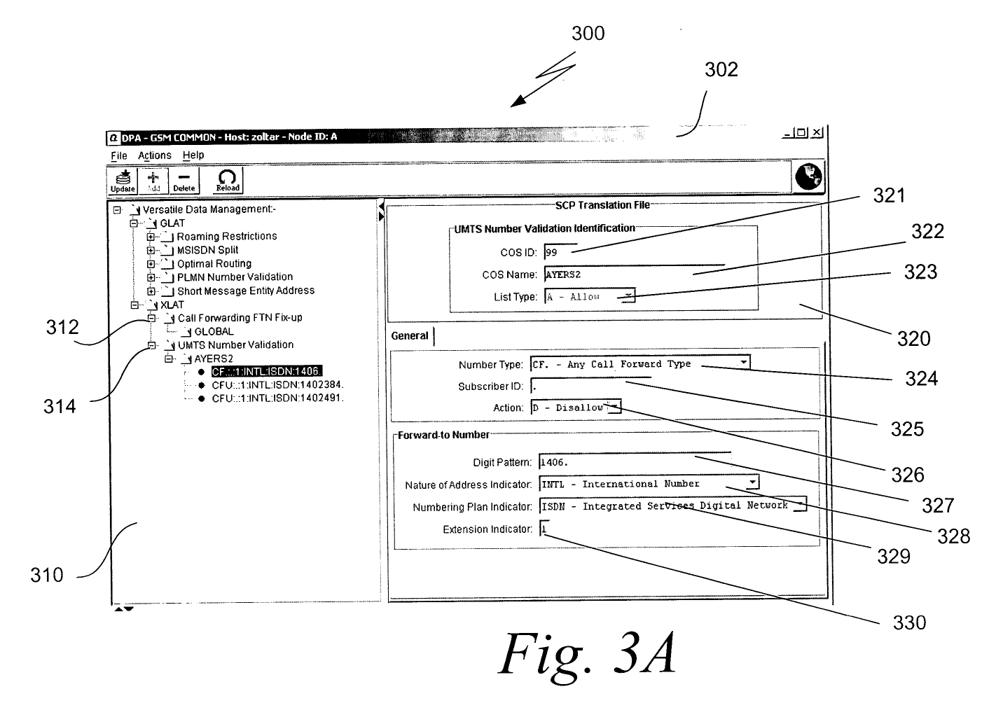

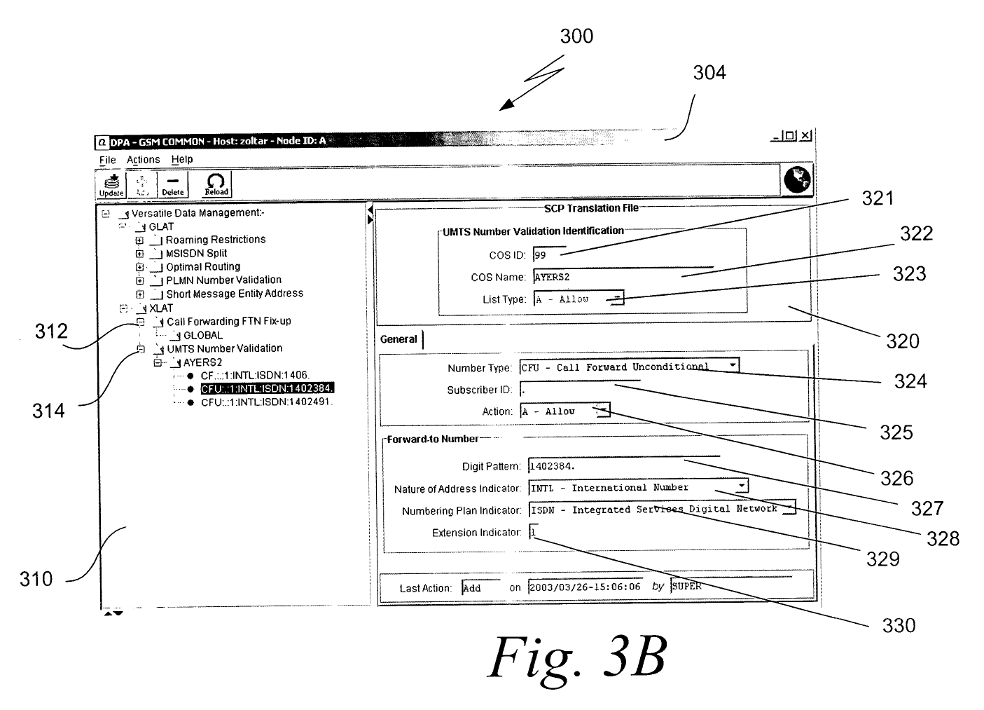

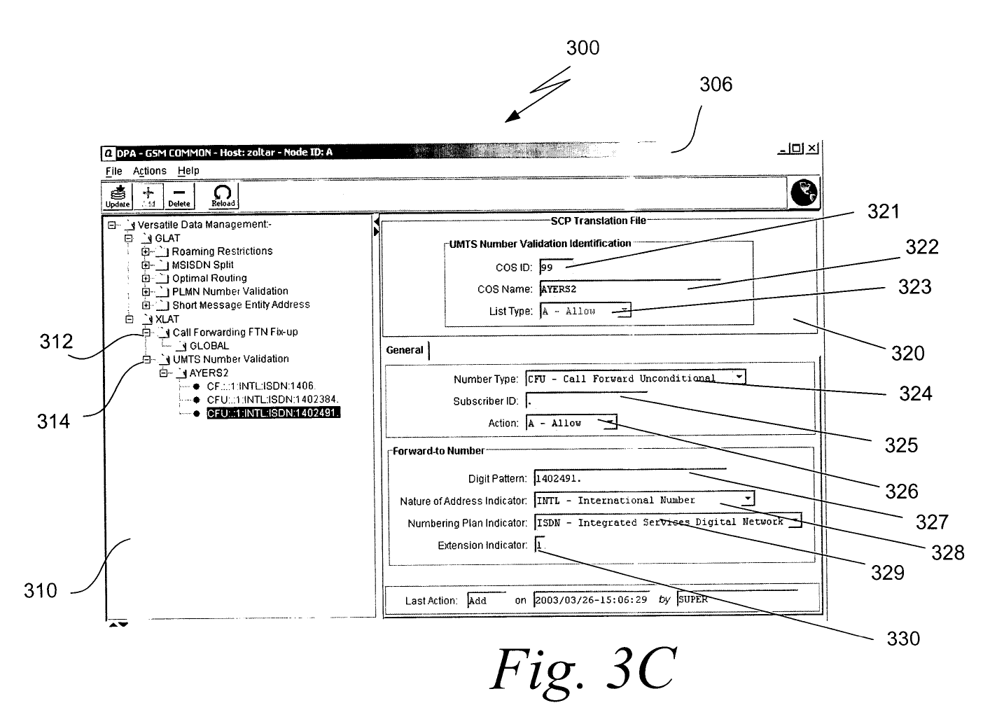

FIGS. 3A-C show example screens of a GUI 300 used to configure the validation rules in one embodiment. The example GUI 300 is displayed on a display device (not shown) that is part of the provisioning subsystem (18 in FIG. 1). The provisioning subsystem 18 is used to configure and modify reconfiguration and validation rules for different classes of service. A user interacts with the GUI 300 to configure the rules. Each class of service has one or more subscribers associated with it. A subscriber 40 may be associated with his or her own class of service, if none of the existing classes of service are desired. By way of example, a subscriber 40 may be associated with a class of service upon purchasing the telephone or calling plan. The salesperson of the telephone or plan may associate the subscriber 40 with a class of service at the same time that the telephone or plan is activated. The salesperson may interact directly with the GUI 300 from a remote terminal located at the salesperson's place of business, or the sales person may call an operator who interacts with the GUI 300. In another example, a subscriber 40 may call an operator who interfaces with the GUI 300 of the provisioning subsystem 18 to configure rules for a new class of service for the subscriber 40 or to change the subscriber's class of service. In still another example, the subscriber 40 may access the GUI 300, or portions of the GUI 300, via a remote terminal (not shown) to select or change the subscriber's own class of service, or to define rules for a new class of service.

FIG. 3A shows an example screen 302 of the GUI 300. The GUI 300 shown in FIG. 3A has a tree portion 310 on the side of the screen 302 and a rule configuration portion 320 on the right side of the screen 302. Rules are configured by entering data in the rule configuration portion 320. Rules are then displayed on the tree portion 310 in a tree format. The tree shown in FIG. 3A includes a branch for rules for reconfiguring the call-forward number, labeled “Call Forwarding FTN Fix-up” 312 and validation rules under the branch “UMTS Number Validation” 314. In the example of FIG. 3A, the validation rules are stored under the subfolder “AYERS2,” which is expanded. Rules are stored with various data fields and are displayed, in the example shown, with data fields separated by colons and with periods used to indicate a “wildcard” variable.

For example, the indication “CFU” refers to the call-forward type, call forward unconditional. Different call-forward types may have different rules associated with them. Other call forward types include, for example, call forward busy, call forward not reachable, and call forward no reply. Call forward busy refers to call forwarding that occurs when the subscriber 40 is busy with another call. Call forward not reachable refers to call forwarding when the subscriber 40 is outside of the subscriber's service area and service cannot be provided to the subscriber 40. Call forward no reply refers to call forwarding when the subscriber 40 is reachable but does not respond to the call. In this example, the characters CFU refer only to call forwarding unconditional. If all other call forwarding features also begin with the characters “CF,” then the data entry “CF.” would refer to all types of call forwarding, as indicated by the period (“.”).

In the example of FIG. 3A, the rule “CF.:.:I:INTL:ISDN:1406.” is selected and the GUI shows details for configuring this rule in the rule configuration portion 320 of the screen 302. This rule applies to all call forwarding, as indicated by the “CF.” data field. The subscriber 40 identifier field is set at “.” indicating that the rule applies to all subscriber 40 identifiers. The “1” is the extension indicator, which in the example of the value “1” indicates that the number has no extension. A “0” in this field would indicate that the parameter has been extended. The “INTL” data indicates that the rule applies to call forward numbers formatted in an international call format. The “ISDN” data indicates that the rule applies to integrated services digital network (ISDN) call-forward numbers. The digits “1406.” indicate that the rule applies to all call-forward numbers beginning with the digits 1406—that is, all numbers in the United States (country code 1) in the area code 406.

The rule configuration portion 302 shows a class of service identifier “99” in a field 321 and a class of service name “AYERS2” in a field 322. Another field 323 allows the user of the GUI to specify whether the call-forward numbers are allowed or disallowed. For the selected rule, a drop-down box 324 allows the selection of a call-forward number type. The selected rule is applicable to all call-forward types, as indicated by the notation “CF.” In other examples, rules might apply only to call-forward unconditional, call forward busy, or any other call-forward type. Another field 325 allows the selection of a particular subscriber 40 identifier. This field may be used, for example, to create a rule that applies only to one particular subscriber 40, rather than to all subscribers associated with the class of service. In this example, the subscriber identifier field 325 is filled with “.” to indicate that the rule applies to all subscribers within the class of service “99.” Another field 326 specifies whether the rule allows or disallows call-forward numbers falling within the rule.

Another field 327 allows the specification of a digit pattern for the call-forward numbers. In this field 327, the rule may be configured to validate or invalidate particular numbers or portions of numbers. The example rule shown in FIG. 3A applies to all calls from the 406 area code, as indicated by the specified digit pattern “1406.” A field 328 allows selection of the nature of the call-forward number, and “INTL” is selected to indicate that the rule applies to numbers having an international format. A numbering plan indicator is also used for another field 329, and integrated services digital network (ISDN) is specified in the example of FIG. 3A. An extension indicator field 330 is used and is set for “1” in the example of FIG. 3A.

FIG. 3B shows another example screen 304 for the second rule shown in the tree portion 310, labeled “CFU:.:1:INTL:ISDN:1402384.” As indicated in the rule configuration portion 320, this example rule allows all call-forward numbers with the 402 area code and 384 prefix.

FIG. 3C shows another example screen 306 for the third rule shown in the tree portion 310, labeled “CFU:.:1:INTL:ISDN:1402491.” As indicated in the rule configuration portion 320, this example rule allows all call forward unconditional call types with the 402 area code and 491 prefix.

The validation rules are stored in a tree format to allow the computer system 10 to readily determine whether a validation rule applies. In use, number reconfiguration and validation rules are configured for a class of service that is associated with only one particular subscriber or for a class of service that is generically associated with a group of subscribers, such as a default class of service. Thereafter, when the subscriber 40 sends the computer system 10 a call-forward number 50, the computer system 10 traverses the tree of validation rules to find a rule for the call-forward number 50. The tree format allows the computer system 10 to quickly traverse each rule, character by character in the string, to determine whether the call-forwarding number fits the digit pattern of the rule.

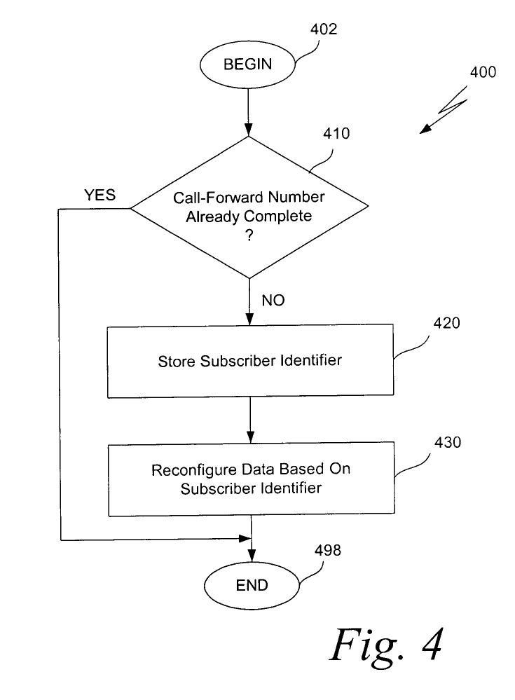

FIG. 4 shows a flow chart of one embodiment 400 of reconfiguring the call-forward number 50, as described at block 130 of FIG. 2. The embodiment 400 begins 402 and determines 410 whether the received call-forward number 50 is already complete. If the call-forward number 50 is already complete (“yes” branch at block 410), then the method 400 ends 498. If the call-forward number is not complete (“no” branch at block 410), then the subscriber's identifier is stored 420. The computer system 10 uses the subscriber identifier to determine the missing digits and reconfigures 430 call-forward number 50 based on the subscriber identifier. The call-forward number 50 is reconfigured 430 by adding the missing digits to the call-forward number 50 and/or by removing any extraneous characters, such as the # or * characters. For example, the computer system 10 may access the subscriber database 14 to retrieve missing digits that are specified for a particular subscriber. In another example, the computer system 10 adds the subscriber's own country code, area code, and/or prefix to call-forward numbers, if no other number rules are specified for the particular subscriber. For example, a subscriber from the United States in the 402 area code might automatically have the United States country code and the 402 area code prepended to all call-forward numbers missing these digits.

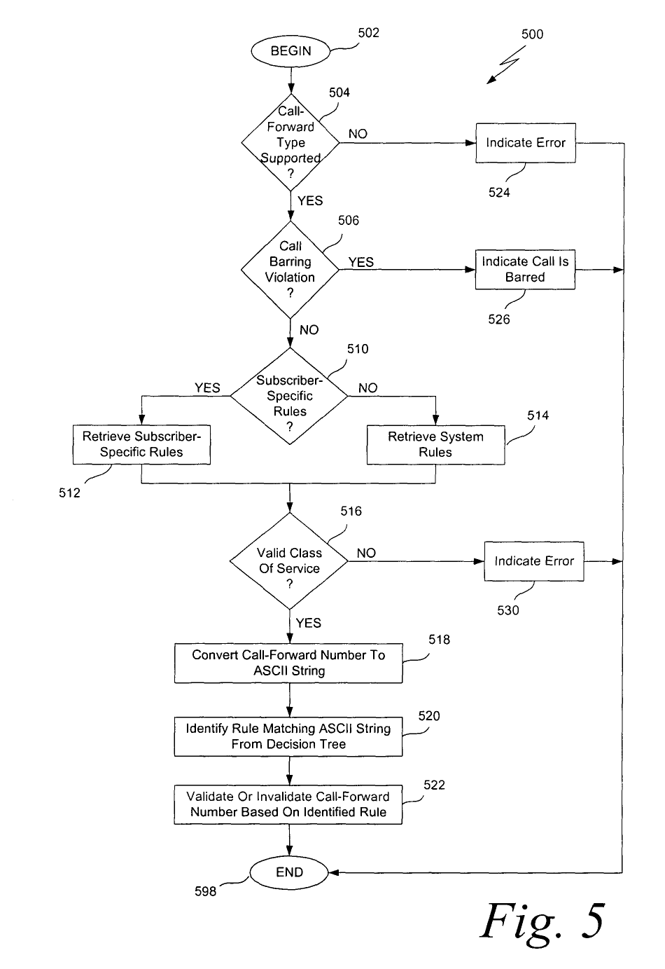

FIG. 5 shows a flow chart of one embodiment 500 of validating call-forward numbers, as described at block 140 of FIG. 2. The example 500 begins 502 and determines 504 whether the call forward type is supported for the subscriber 40. If the call-forward type selected by the subscriber 40 is not supported by the system 10 (e.g., if it is a new type of call-forwarding that the system 10 does not support, or by the subscriber's plan, then an error is indicated 526 and the method ends 598. If the call forward type is supported (“yes” branch at block 504), then the computer system 10 determines 506 whether there is a call barring violation. Call forwarding may be temporarily barred, for example, if the subscriber 40 is not current with his or her monthly bill for calling services. If the call forwarding is barred (“yes” branch at block 506), then the computer system 10 indicates that call forwarding is barred 526, and this embodiment 500 ends 598.

If there is no call forward barring violation (“no” branch at block 506), then the computer system 10 determines 510 whether the subscriber 40 is associated with a subscriber-specific class of service (i.e., a class of service that applies to only one subscriber). If the subscriber 40 is associated with a subscriber-specific class of service, then the computer system 10 retrieves 512 the rules associated with the subscriber-specific class of service. Otherwise, the computer system 10 retrieves 514 rules for a generic class of service to validate the call. The computer system 10 determines 516 whether the subscriber 40 is associated with a valid class of service. If the subscriber 40 is not associated with a valid class of service (“no” branch at block 516), then the computer system 10 indicates 530 that an error exists and the method 500 ends 598. If the subscriber 40 is associated with a valid class of service (“yes” branch at block 516), then the computer system 10 converts 518 the call-forward number to an ASCII string in the same format as the validation rules. The computer system 10 identifies 520 an applicable rule from ASCII string rules of the decision tree. The computer system 10 compares the ASCII string of the call-forward number with the ASCII string rules of the decision tree, by traversing the tree and comparing the strings character by character. Based on the identified rule, the call-forward number 522 is validated or invalidated and this example ends 598.

Although the present invention has been described with respect to particular embodiments thereof, variations are possible. The present invention may be embodied in specific forms without departing from the essential spirit or attributes thereof In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

1. A method of processing call-forward telephone numbers for a subscriber associated with a computer system, the method comprising:
receiving a call-forward number for the subscriber;
identifying a class of service associated with the subscriber;
reconfiguring the call-forward number based on the class of service;
validating the call-forward number based on the class of service; and
storing the reconfigured call-forward number based on the validating.

2. The method of claim 1, further comprising configuring validation rules using a call-forward number validation tree, and wherein the step of validating comprises traversing the tree to determine whether the call-forward number is valid.

3. The method of claim 2, wherein the step of configuring comprises, for each of the rules, prompting a user through a graphical user interface for a call-forward number type, a subscriber identifier, an action type that specifies whether the rule allows or disallows call-forward numbers falling within the rule, a digit pattern, a nature of address indicator, and a numbering plan indicator.

4. The method of claim 3, wherein the call-forward number type is call forward unconditional, call forward busy, call forward no reply, or call forward not reachable.

5. The method of claim 2, wherein the step of receiving the call-forward number comprises receiving a digit pattern for the call-forward number, and wherein the step of reconfiguring comprises adding one or more digits to the digit pattern to create a complete call-forward number based on the class of service for the subscriber.

6. The method of claim 1, further comprising forwarding an incoming call for the subscriber to the stored, reconfigured call-forward number.

7. A computer system for processing call-forward numbers received for a subscriber of the system, comprising:
a storage medium; and
a processor for executing a software program stored on the storage medium, the software program comprising a set of instructions for:
receiving a call-forward number for the subscriber;
determining whether the call-forward number requires reconfiguration;
identifying a class of service associated with the subscriber;
reconfiguring the call-forward number based on the class of service;
storing the reconfigured call-forward number; and
redirecting incoming calls based on the reconfigured call-forward number.

8. The system of claim 7, wherein the step of receiving the call-forward number comprises receiving the call-forward number from the subscriber in a supplemental services message initiated remotely from a telecommunications device associated with the subscriber.

9. The system of claim 7, wherein the step of reconfiguring comprises prepending one or more missing digits to the call-forward number based on information associated with the subscriber.

10. The system of claim 9, wherein the step of reconfiguring comprises prepending a country code associated with the subscriber to the call-forward number if the call-forward number received from the subscriber is missing a country code.

11. The system of claim 7, wherein the step of reconfiguring comprises deleting one or more extraneous characters from the received call-forward number.

12. The system of claim 7, wherein the software program further comprises a set of instructions for validating the call-forward number based on rules associated with the class of service for the subscriber.

13. The system of claim 12, wherein the set of instructions for validating comprises a set of instructions for converting the call-forward number to an ASCII string and identifying a rule associated with the call-forward number by traversing a decision tree of rules stored as ASCII strings in a common format as the ASCII string of the call-forward number and comparing the ASCII string of the call-forward number character by character with each of the ASCII strings of the rules.

14. The system of claim 12, wherein the system further comprises:
a provisioning subsystem that configures the rules for the class of service, wherein the provisioning subsystem includes a graphical user interface that displays the rules in a decision tree structure; and
a call processing subsystem that processes the incoming calls.

15. A computer-readable medium having computer-executable instructions for performing a method of processing call-forward numbers for a subscriber, the method comprising:
receiving a call-forward number for the subscriber;
identifying a class of service associated with the subscriber;
identifying one or more validation rules for the class of service; and
validating the call-forward number based on the rules.

16. The medium of claim 15, wherein the method further comprises converting the call-forward number to an ASCII string, and wherein the step of identifying one or more rules comprises traversing a decision tree of rules that are stored as ASCII strings, and determining whether the call-forward number falls within any of the rules in the tree by comparing the ASCII string of the call-forward number to the ASCII strings of the rules, character by character.

17. The medium of claim 15, wherein the method further comprises reconfiguring the call-forward number as a complete number by adding one or more missing digits to the call-forward number, based on the class of service of the subscriber.

18. The medium of claim 15, wherein the method further comprises configuring validation rules associated with the subscriber's class of service, using a graphical user interface to configure the validation rules in software, wherein the validation rules may be dynamically changed for the class of service.

19. The medium of claim 15, wherein the method further comprises forwarding a call to the call-forward number based on the validating.

20. An apparatus for processing call-forward numbers for a subscriber, comprising:
means for reconfiguring a call-forward number based on a class of service associated with the subscriber, to make the call-forward number a complete number;
means for validating the call-forward number based on the class of service, by traversing a decision tree of validation rules and comparing the call-forward number with the validation rules to identify an applicable validation rule; and
means for forwarding an incoming call to the reconfigured call-forward number, if the call-forward number is valid.

21. The apparatus of claim 20, further comprising means for converting the call-forward number to an ASCII string, and wherein the means for validating comprises means for comparing, character by character, the ASCII string of the call-forward number to ASCII strings associated with the validation rules in the decision tree.

22. The apparatus of claim 20, wherein the means for reconfiguring comprises means for adding digits to the call-forward number if the call-forward number is missing digits and means for removing extraneous characters from the call-forward number, if the call-forward number includes extraneous characters.
